(19) United States
(12) Patent Application Publication
(10) Pub. No.: US 2012/0038574 A1
(43) Pub. Date: Feb. 16, 2012

(54) DETECTION METHOD AND DETECTION CIRCUIT FOR DETECTING TOUCH EVENT ON TOUCH PANEL BY SELECTING NON-ADJACENT SENSING AXIS AS REFERENCE AXIS

(76) Inventors: Shih-Chin Chang, Hsinchu City (TW); Shih-Tzung Chou, Hsinchu County (TW); Tung-Ke Wu, Taipei City (TW)

(21) Appl. No.: 13/207,419

(22) Filed: Aug. 11, 2011

(30) Foreign Application Priority Data
Aug. 11, 2010 (TW) 099126725

(51) Int. Cl. G06F 3/041

(52) U.S. Cl. 345/173

(57) ABSTRACT

A detection method for detecting a touch event on a touch panel includes a plurality of first sensing axes on a first dimension, and a plurality of second sensing axes on a second dimension. The detection method includes: regarding each first sensing axis, choosing another first sensing not neighboring with the first sensing axis as a first reference axis, and utilizing the first sensing axis and the first reference axis to derive a first sensing data corresponding to the first sensing axis; utilizing the second axes to derive a second sensing data corresponding to each second sensing axis; and utilizing first sensing data respectively corresponding to the first sensing axes and second sensing data respectively corresponding to the second sensing axes to derive a touch event detection result.

### BACKGROUND OF THE INVENTION

1. Field of the Invention

The disclosed embodiments of the present invention relate to touch control technology, and more particularly, to a detection method for detecting a touch event on a touch panel and related detection circuit thereof.

2. Description of the Prior Art

In modern electronic products, a capacitive touch panel is often used as a man-machine interface due to its intuitive-to-use characteristic, wherein a projective capacitive touch panel has benefits of multi-touch support, higher transmittance and power conservation, and thus is widely used on portable devices such as mobile phones, vehicle navigation devices, etc. However, measurement of the projective capacitive touch panel usually has only several or dozens of sensing electrodes disposed in a direction of a horizontal axis or vertical axis, and the sensing electrodes of the touch panel respectively generate a plurality of sensing signals according to a touch event thereon, and respectively generate a plurality of sensing outputs according to differences of sensing signals generated by each pair of adjacent sensing electrodes. In the prior arts, a calculation of a contact usually employs an interpolation method for estimating a distance between a measured point and a peak value via an estimated peak value determined by the calculated sensing output or a ratio of the calculated sensing output value to an extreme value. Please refer to FIG. 1, which is a schematic diagram illustrating an example of detecting a touch event TEa on a conventional touch panel 100. As shown in FIG. 1, the conventional touch panel 100 has 6 sensing axes X1˜X6 and Y1˜Y6 on the X axis and Y axis, respectively, and the sensing axes X1˜X6 and Y1˜Y6 have corresponding sensing output values SX1a˜SX6a and SY1a˜SY6a, respectively. For example, regarding the sensing axes X1˜X6, only the sensing output values SX3a˜SX5a are effective values (i.e., non-zero values). The sensing output value SX3a is obtained by a detection circuit comparing the sensing signal detected by the sensing axis X3 and the sensing signal detected by the sensing axis X2; similarly, the sensing output value SX4a and the sensing output value SX5a are obtained by the detection circuit comparing the sensing signals detected by the sensing axis X4, X5 and X5, X6, respectively. Contacts of the touch event TEa can be known to be located between the sensing axis X3 and X4 via calculating these effective values with the interpolation method. In the same manner, contacts of the touch event TEa can be known to be located on the sensing axis Y4 via calculating effective values (i.e. SY3a˜SY5a) corresponding to the sensing axis Y1˜Y6.

Please refer to FIG. 2, which is a schematic diagram illustrating an example of detecting another touch event TEb on the conventional touch panel 100. Compared to the touch event TEa, contacts of the touch event TEb are smaller, which cannot cover areas of sensing electrodes in the touch panel 100, and thus a number of effective values decreases. In the example shown in FIG. 2, only the sensing output values SX3b˜SX4b and SY4b are effective values, and therefore positions of the contacts cannot be accurately obtained in the following calculation using the interpolation method. Moreover, when the touch event TEb is a contact in motion (e.g., a user uses a touch pen to slide on the touch panel 100), a trace of the detected contacts would present non-linear characteristics due to lack of efficient effective values, and thus leads to poorer system performance.

Hence, how to increase effective data detected on the touch panel 100 for increasing linearity of detected data is still a problem needed to be solved in the field.

### SUMMARY OF THE INVENTION

In accordance with exemplary embodiments of the present invention, a detection method capable of increasing effective detected data so as to improve linearity of detected data and related detection circuit thereof are proposed to solve the above-mentioned problem.

According to one embodiment of the present invention, a detection method for detecting a touch event on a touch panel including a plurality of first sensing axes on a first dimension and a plurality of second sensing axes on a second dimension is disclosed. The detection method includes: regarding each first sensing axis, choosing another first sensing not neighboring with the first sensing axis as a first reference axis, and utilizing the first sensing axis and the first reference axis to derive a first sensing data corresponding to the first sensing axis; utilizing the second axes to derive a second sensing data corresponding to each second sensing axis; and utilizing first sensing data respectively corresponding to the first sensing axes and second sensing data respectively corresponding to the second sensing axes to derive a touch event detection result.

According to another embodiment of the present invention, a detection circuit for detecting a touch event on a touch panel including a plurality of first sensing axes on a first dimension and a plurality of second sensing axes on a second dimension is disclosed. The detection circuit includes a scanning element and a determining element. Regarding each of the first sensing axes, the scanning element selects a first sensing axis which is not adjacent to the first sensing axis as a first reference axis, utilizes the first sensing axis and the first reference axis to obtain a first sensing data corresponding to the first sensing axis; and further obtains a second sensing data corresponding to each of the second sensing axis according to the second sensing axes. The determining element is coupled to the scanning element, for obtaining a touch event detection result according to a plurality of first sensing data respectively corresponding to the first sensing axes and a plurality of second sensing data respectively corresponding to the second sensing axes.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating an example of detecting a touch event on a conventional touch panel.

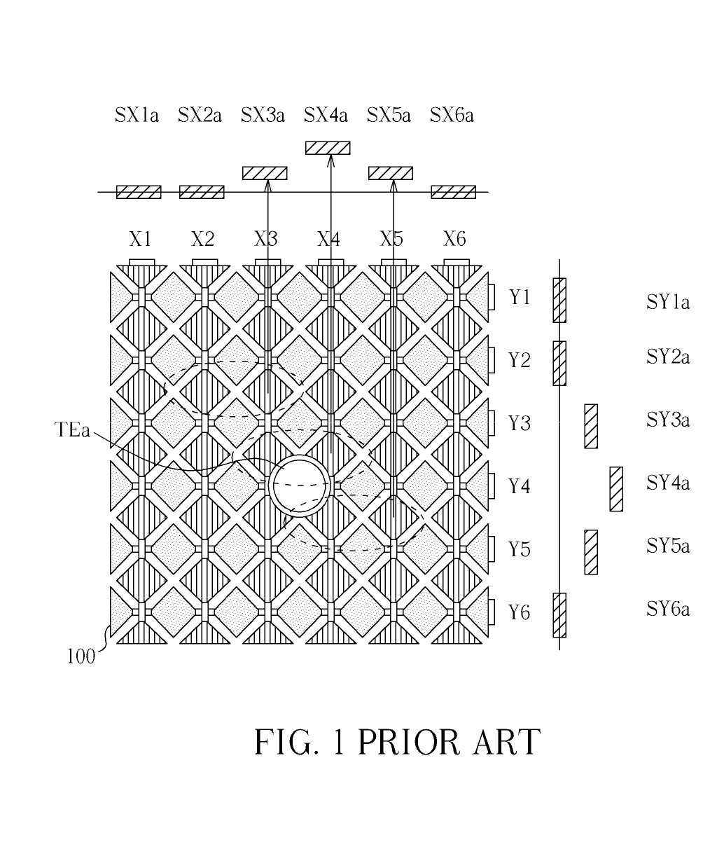

FIG. 2 is a schematic diagram illustrating an example of detecting another touch event on the conventional touch panel.

FIG. 3 is a schematic diagram of a detection circuit according to one embodiment of the present invention.

FIG. 4 is a schematic diagram illustrating detection of a touch event on a touch panel according to one embodiment of the present invention.

### DETAILED DESCRIPTION

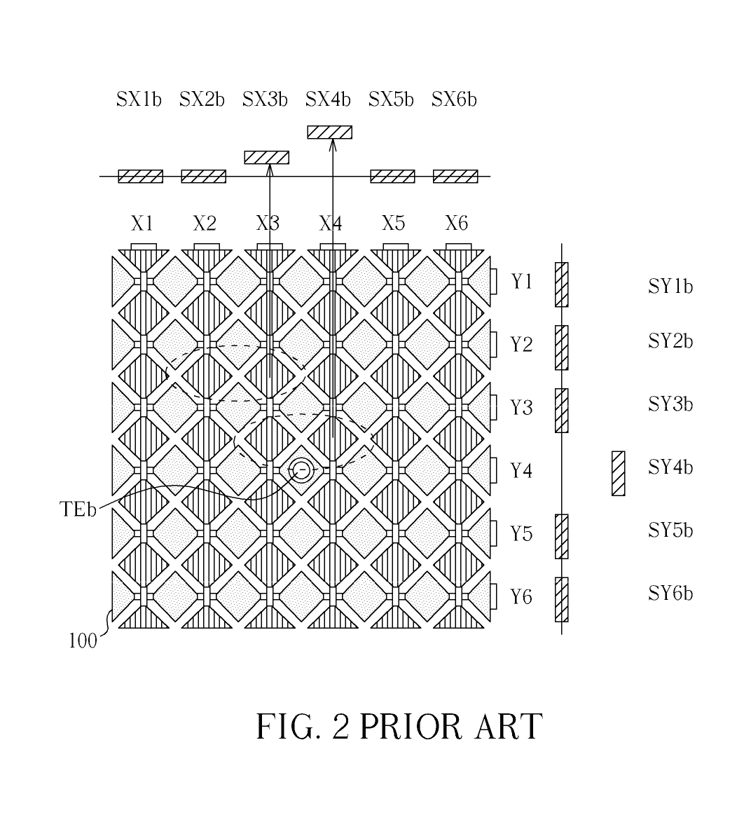

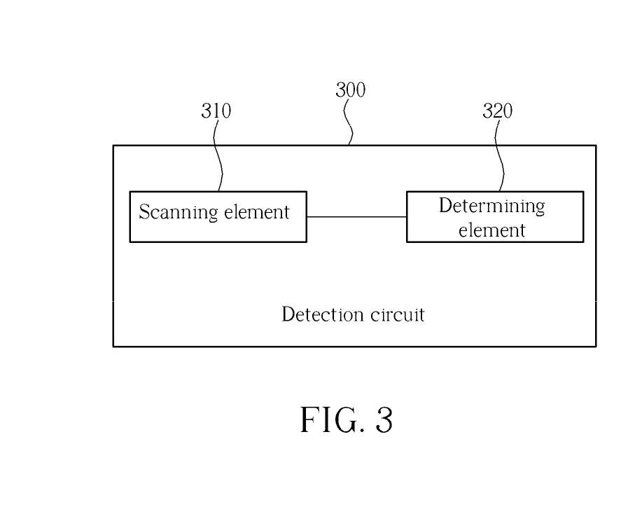

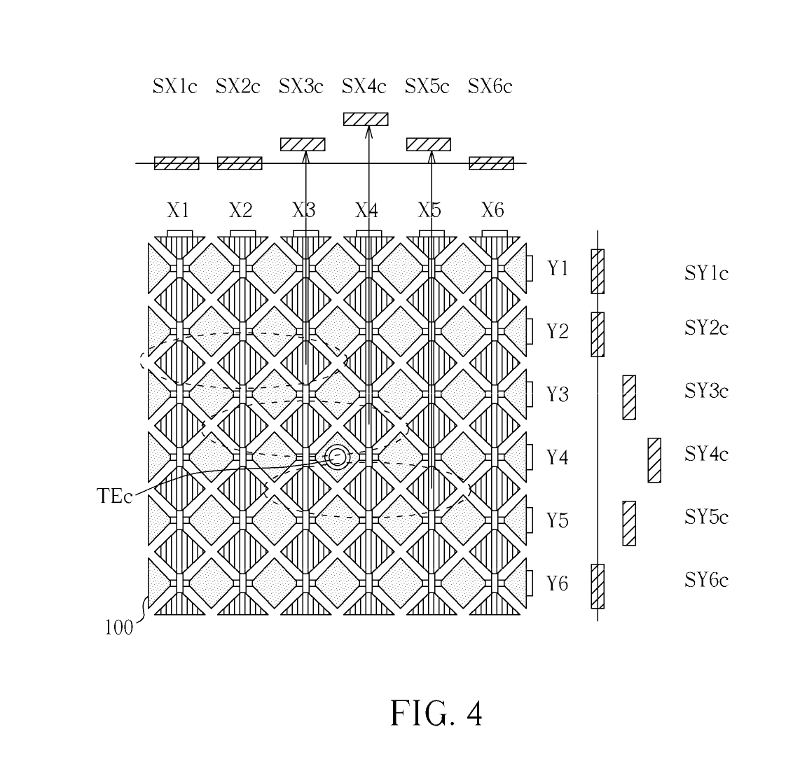

Please concurrently refer to FIG. 3 and FIG. 4. FIG. 3 is a schematic diagram of a detection circuit 300 according to one embodiment of the present invention, and FIG. 4 is a schematic diagram illustrating detection of a touch event TEc on a touch panel 100 according to one embodiment of the present invention. The touch event TEc in FIG. 4 and the touch event TEb in FIG. 2 have contacts with the same contact areas. The detection circuit 300 includes, but not limited to, a scanning element 310 and a determining element 320. The touch panel 100 includes 6 first sensing axes X1˜X6 and 6 second sensing axes Y1˜Y6 on a first dimension (e.g., the X axis) and a second dimension (e.g., the Y axis), respectively. Please note that, the number of the first and second sensing axes is for illustrative purpose only, and is not meant to be a limitation of the present invention. In this embodiment, when the scanning element 310 extracts a sensing output of a specific sensing axis, the scanning element 310 selects a sensing axis which is not adjacent to the specific sensing axis as a reference axis, and utilizes the sensing axis and the reference axis to obtain a sensing data corresponding to the specific sensing axis (i.e., obtain the sensing output corresponding to the specific sensing axis).

For example, when the scanning element 310 extracts a sensing output of the first sensing axis X3, the scanning element 310 selects a first sensing axis X1, which is separated by a first sensing axis X2, as a first reference axis, and utilizes the sensing signal corresponding to a first sensing axis X3 (i.e., the aforementioned specific sensing axis) to be compared with the corresponding first sensing axis X1 (i.e., the aforementioned reference axis), thereby obtaining a sensing output SX3c corresponding to the first sensing axis X3 by calculation; similarly, when the scanning element 310 extracts a sensing output of a second sensing axis Y3, the scanning element 310 selects a second sensing axis Y1, which is separated by a second sensing axis Y2, as a second reference axis, and utilizes a sensing signal corresponding to a second sensing axis Y3 (i.e., the aforementioned specific sensing axis) to be compared with the corresponding first sensing axis Y1 (i.e., the aforementioned reference axis), thereby obtaining a sensing output SY3c corresponding to the second sensing axis Y3 by calculation. By the same token, the scanning element 310 processes the first sensing axes X1˜X6 and second sensing axes Y1˜Y6 one-by-one, to obtain the sensing outputs SX1c˜SX6c and SY1c˜SY6c corresponding to the first sensing axes X1˜X6 and the second sensing axes Y1˜Y6, respectively. After all the first sensing data and the second sensing data (i.e., sensing outputs SX1c˜SX6c and SY1c˜SY6c) are obtained, the determining element 320 retrieves effective data from the first and second sensing data to determine a detection result of the touch event.

Please concurrently refer to FIG. 2 and FIG. 4. As can be known from the figures, effective data shown in FIG. 4 include the sensing outputs SX3c˜SX5c and SY3c˜SY5c, and the number thereof is greater than the number of effective data (i.e., sensing outputs SX3b˜SX4b and SY4b) in FIG. 2. Therefore, the detection circuit 300 can rapidly and precisely identify positions of the contacts corresponding to the touch event TEc according to these effective data.

However, the above-mentioned embodiments are for illustrative purpose only, and are not meant to be limitations to the scope of the present invention. For example, when extracting sensing output of the first sensing axis X3 (or the second sensing axis Y3), the scanning element 310 selects the first sensing axis X5 (or the second sensing axis Y5) separated by the first sensing axis X4 (or the second sensing axis Y4) or selects the even farther first sensing axis X6 (or the second sensing axis Y6) as the first reference axis (or the second reference axis), and obtains the sensing output corresponding to the first sensing axis X3 (or the second sensing axis Y3) via calculating a difference of sensing signals between the selected first reference axis (or the second reference axis) and the first sensing axis X3 (or the second sensing axis Y3). In other words, a detection method, including steps of selecting a first sensing axis (or a second sensing axis) which is not adjacent to a first specific sensing axis (or a second specific sensing axis) as the first reference axis (or the second reference sensing axis) and accordingly obtaining a first sensing data (or a second sensing data) corresponding to the first specific sensing axis (or the second specific sensing axis), should fall within the scope of the present invention.

To sum up, the present invention provides a detection method capable of increasing effective detected data. When calculating a sensing output of a sensing axis, another sensing axis which is not adjacent to the sensing axis is selected as a reference axis, and the sensing output corresponding to the sensing axis is generated correspondingly. In this way, the present invention can still obtain enough effective detected data even though the contact areas are too small. As the linearity of detected data is enhanced, the accuracy of the final contact detection result/touch event detection result can be improved.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A detection method for detecting a touch event on a touch panel, the touch panel including a plurality of first sensing axes on a first dimension and a plurality of second sensing axes on a second dimension, respectively, the detection method comprising:
regarding each of the first sensing axes:
selecting a first sensing axis which is not adjacent to the first sensing axis as a first reference axis, and utilizing the first sensing axis and the first reference axis to obtain a first sensing data corresponding to the first sensing axis;
utilizing the second sensing axes to obtain a second sensing data corresponding to each of the second sensing axes; and
obtaining a touch event detection result according to a plurality of first sensing data respectively corresponding to the first sensing axes and a plurality of second sensing data respectively corresponding to the second sensing axes.

2. The detection method of claim 1, wherein the first reference axis and the first sensing axis are only separated by one first sensing axis.

3. The detection method of claim 1, wherein the step of utilizing the second sensing axes to obtain the second sensing data corresponding to each of the second sensing axes comprises:
regarding each of the second sensing axes:
selecting a second sensing axis which is not adjacent to the second sensing axis as a second reference axis, and utilizing the second sensing axis and the second reference axis to obtain the second sensing data corresponding to the second sensing axis.

4. The detection method of claim 3, wherein the first reference axis and the first sensing axis are only separated by one first sensing axis, and the second reference axis and the second sensing axis are only separated by one second sensing axis.

5. A detection circuit for detecting a touch event on a touch panel, the touch panel including a plurality of first sensing axes on a first dimension and a plurality of second sensing axes on a second dimension, respectively, the detection circuit comprising:
a scanning element, wherein regarding each of the first sensing axes, the scanning element selects a first sensing axis which is not adjacent to the first sensing axis as a first reference axis, and utilizes the first sensing axis and the first reference axis to obtain a first sensing data corresponding to the first sensing axis; and the scanning element further obtains a second sensing data corresponding to each of the second sensing axis according to the second sensing axes; and
a determining element, coupled to the scanning element, for obtaining a touch event detection result according to a plurality of first sensing data respectively corresponding to the first sensing axes and a plurality of second sensing data respectively corresponding to the second sensing axes.

6. The detection circuit of claim 5, wherein the first reference axis and the first sensing axis are only separated by one first sensing axis.

7. The detection circuit of claim 5, wherein regarding each of the second sensing axis, the scanning element selects a second sensing axis which is not adjacent to the second sensing axis as a second reference axis, and utilizes the second sensing axis and the second reference axis to obtain the second sensing data corresponding to the second sensing axis.

8. The detection circuit of claim 7, wherein the first reference axis and the first sensing axis are only separated by one first sensing axis, and the second reference axis and the second sensing axis are only separated by one second sensing axis.
